(19) United States
(12) Patent Application Publication
(10) Pub. No.: US 2011/0211212 A1
(43) Pub. Date: Sep. 1, 2011

(54) DOCUMENT PROCESSING AND DISTRIBUTION USING CUSTOMIZED PROCESS PRINT DRIVERS

(76) Inventors: Jean-Jacques Berard, Villeurbanne (FR); Laurent Mascher, Lyon (FR); Stéphane Lichtenberger, Tupin et Semons (FR)

(21) Appl. No.: 12/722,122

(22) Filed: Mar. 11, 2010

Related U.S. Application Data
(60) Provisional application No. 61/309,167, filed on Mar. 1, 2010.

(51) Int. Cl. G06F 3/12

(52) U.S. Cl. 358/1.13

(57) ABSTRACT

Systems and methods for automated processing and distribution of documents using a customized print driver. The customized print driver is accessed using a program application running on an Internet-enabled or networkable device. Unlike conventional print drivers which output print file from an application program to, for example, a laser printer, the customized print drivers combine a print file from the application program with specific processing and distribution parameters or preferences (i.e., a macro). The macro includes, among other things, preferences related to transport medium, transport options, and contact information. By combining the print file of the application program with the macro using a customized print driver, documents are able to be electronically prepared, processed, and distributed efficiently and with minimal user intervention.

### RELATED APPLICATIONS

This application claims the benefit of previously-filed, co-pending U.S. Provisional Patent Application No. 61/309,167, filed Mar. 1, 2010, the entire content of which is hereby incorporated by reference.

### BACKGROUND

The present invention relates to document processing and distribution.

The processing and distribution of documents, such as invoices, is important to most businesses. For example, the ability to generate, process, and distribute invoices is important for maintaining a business's revenue stream. In many instances, an invoice or another document is prepared using a computer, printed, prepared for transmittal, and manually sent to a client. Such a process requires a substantial amount of employee intervention to process a single document, which may result in errors. Such a process is also complicated by clients who have different transmittal preferences. For example, a first client may want a document sent via email, a second client may want a document faxed, and a third client may want a document mailed as a hard copy. The differences in preferences among clients and the level of employee intervention make the processing and distribution of documents susceptible to errors, such as, among others, transcription errors (e.g., writing or entering an incorrect address), routing errors (e.g., sending a document to the wrong client), and transmittal errors (e.g., sending a document via email instead of hard copy).

### SUMMARY

Automating the processing and distribution of documents and minimizing employee intervention reduces the likelihood of errors and delays. In one embodiment of the invention, the processing and distribution of documents is automated using a customized print driver which is accessible from, for example, an employee workstation or another networkable device. Unlike conventional printer drivers which output a data stream from an application program (e.g., a word processor) to, for example, a laser printer, the customized print drivers of this invention combine an output data stream from an application program with customer specific processing and distribution preferences. These preferences include, among other things, transport medium, transport options, and contact information. By combining an output data stream of an application program with customer specific processing and distribution preferences using a customized print driver, documents are able to be electronically prepared, processed, and distributed with minimal employee intervention.

Embodiments of the invention also provide a system and method for generating such a customized print driver. The system includes a host device which is configured to receive an output data stream or print file from an application (e.g., a word processor, a spreadsheet, etc.) that is related to a document (e.g., an invoice). A set of parameters related to the processing and distribution of the document is provided to the host device by a user. The parameters include, for example, transport type (e.g., mail, fax, email, etc.), address, fax number, mail type, number of copies, and the like. The parameters are then saved as a macro or data set. A print driver is generated which includes at least a reference to the macro. The print driver is then published such that it is accessible by at least one client device. When executed, the print driver accesses the macro, and the parameters related to the processing and distribution of the document are provided to the host device.

In one embodiment, the invention provides a method of automatically processing and distributing a document to at least one of a plurality of destinations. The plurality of destinations including a fax number, an email address, and a postal address. The method includes receiving, at a host device, a print file from an Internet-enabled device, generating at least one macro based on processing and distribution parameters received from a user, and storing the at least one macro based at least in part on the processing and distribution parameters. A customized print driver is generated based on the at least one macro, and a reference to the at least one macro is embedded within the customized print driver. The process also includes making the customized print driver available to the Internet-enabled device, and preparing the print file for distribution to at least one of the plurality of destinations based on the processing and distribution parameters included within the at least one macro.

In another embodiment, the invention provides a method of distributing a document to at least one of a plurality of destinations. The method includes receiving, at a host device, a print file from a client device, which is sent to the host device using a customized print driver. The process also includes accessing at least one macro based on information embedded within the customized print driver. The at least one macro includes a set of parameters related to processing and distribution preferences for the print file. The print file is then prepared for distribution based on the at least one macro.

In another embodiment, the invention provides a system for initiating distribution of a document to at least one of a plurality of destinations. The system includes a client device and a host device. The client device is configured to transmit a print file using a customized print driver. The host device includes a memory and a processor. The processor is connected to the memory and is configured to access at least one macro based on information embedded within the customized print driver, and the print file is prepared for distribution to at least one of a plurality of destinations based on information included within the at least one macro.

In another embodiment, the invention provides a device for initiating distribution of a document to at least one of a plurality of destinations. The device includes a memory and a processor. The processor is connected to the memory and is configured to receive a print file and access at least one macro based on information embedded within a customized print driver. The at least one macro includes a set of parameters related to processing and distribution preferences for the print file, and the print file is prepared to be distributed to at least one of the plurality of destinations based on information included within the at least one macro.

Other aspects of the invention will become apparent by consideration of the detailed description and accompanying drawings.

### BRIEF DESCRIPTION OF THE DRAWINGS

FIG. 1 illustrates a document processing system according to an embodiment of the invention.

FIG. 2 illustrates a system for generating a customized print driver according to an embodiment of the invention.

FIG. 3 illustrates a process printing system according to an embodiment of the invention.

FIG. 4 illustrates a transport selection interface according to an embodiment of the invention.

FIG. 5 illustrates a transport selection interface according to another embodiment of the invention.

FIG. 6 illustrates a transport options interface according to an embodiment of the invention.

FIG. 7 illustrates a summary interface according to an embodiment of the invention.

FIG. 8 illustrates a summary interface according to another embodiment of the invention.

FIG. 9 illustrates a process printing interface according to an embodiment of the invention.

FIG. 10 is a process for generating a customized print driver according to an embodiment of the invention.

FIGS. 11-14 illustrate the process of FIG. 10 in greater detail.

FIG. 15 is a process for automatically processing a document according to an embodiment of the invention.

### DETAILED DESCRIPTION

Before any embodiments of the invention are explained in detail, it is to be understood that the invention is not limited in its application to the details of construction and the arrangement of components set forth in the following description or illustrated in the following drawings. The invention is capable of other embodiments and of being practiced or of being carried out in various ways.

Embodiments of the invention described herein relate to a system and method for automating document processing and distribution using a customized print driver. The system includes a host device which is configured to receive an output data stream or print file from a program application, such as a word processor, that is related to a document (e.g., an invoice). A set of parameters related to the processing and distribution of the document is accessed based at least in part on information embedded within the print driver. The parameters include, for example, transport type (e.g., mail, fax, email, etc.), address, fax number, mail type, number of copies, and the like. The customized print driver is generated based on user entered information related to a particular document and how the document is to be processed and distributed. As such, a plurality of independent print drivers is dynamically generated based on clients' needs and preferences. The customized print drivers are published such that they are accessible by any number of client devices (e.g., employee workstations, etc.). The customized print drivers are selectable in a manner similar to the selection of a conventional printer for printing.

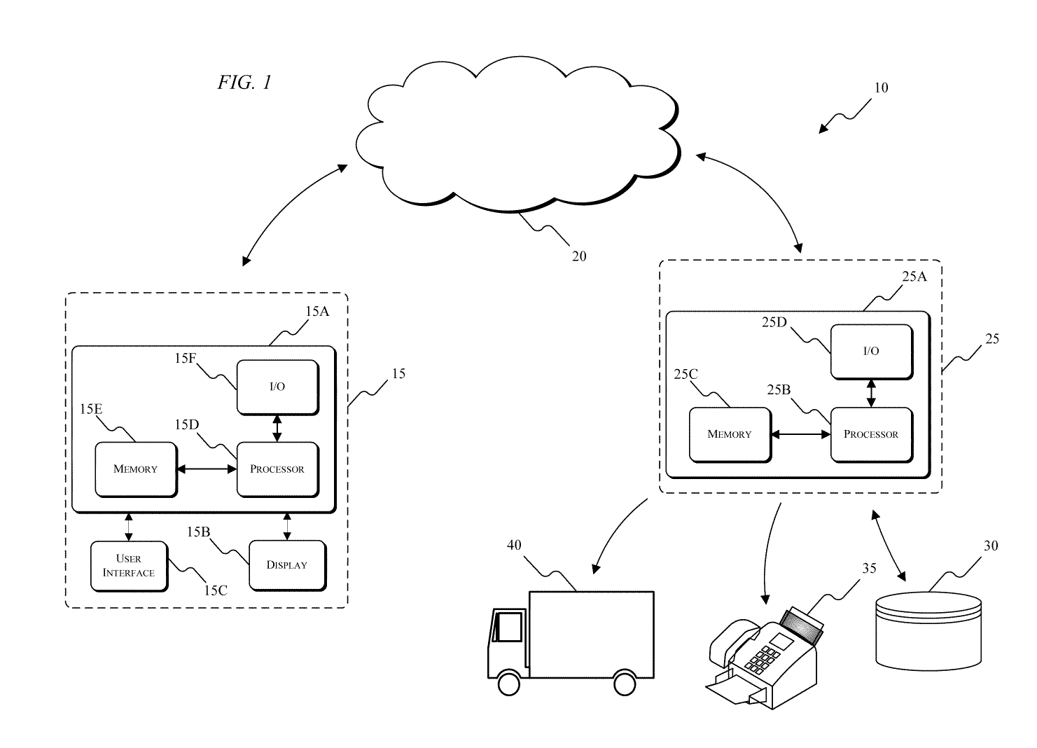

A system 10 for automated document processing and distribution is illustrated in FIG. 1. The system 10 includes a client device 15, a network 20, a host device 25, a database 30, a fax machine 35, and a mail and print service 40. In the illustrated embodiment, the client device 15 is, for example, a personal computer. However, in other embodiments, the client device 15 is any device which is capable of accessing the network 20 (e.g., the Internet) and running a word processing or viewing application. Such devices include mobile phones, laptop computers, tablet computers, personal digital assistants (“PDAs”), Wi-Fi enabled media devices, e-book readers, and the like. The client device 15 includes, among other things, a controller or control module 15A, a display 15B, and a user interface 15C. The controller 15A includes a processor 15D, a memory 15E, such as a read-only memory (“ROM”), a random access memory (“RAM”), an electrically erasable programmable read-only memory (“EEPROM”), a flash memory, or the like, and an input/output (“I/O”) interface 15F. The client device 15 is connectable to the host device 25 (e.g., a server) over the network 20. The host device 25 includes, among other things, a controller or control module 25A, a processor 25B, a memory 25C, such as a ROM, a RAM, an EEPROM, a flash memory, or the like, and an I/O interface 25D. The network 20 is, for example, as wide area network (“WAN”) (e.g., the Internet, a GSM network, an EDGE network, a PCS network, a D-AMPS network, etc.), a local area network (“LAN”) (e.g., Ethernet, etc.), or personal area network (“PAN”) (e.g., Wi-Fi, Bluetooth, ZigBee, etc.). The host device 25 is connected to an external memory for storing information related to the processing and distribution of documents, such as the database 30. The host device 25 is also connected to a mail and print service 40 which receives a print and mail request from the host device 25, and the fax machine 35 which receives a fax request from the host device 25. The host device 25 is also configured to process and send documents over the network 20 via email. In addition to communicating over the network 20, the host device 25 is also capable of communicating using additional or different services and protocols, such as short message service (“SMS”), multimedia messaging service (“MMS”), simple mail transfer protocol (“SMTP”), and the like.

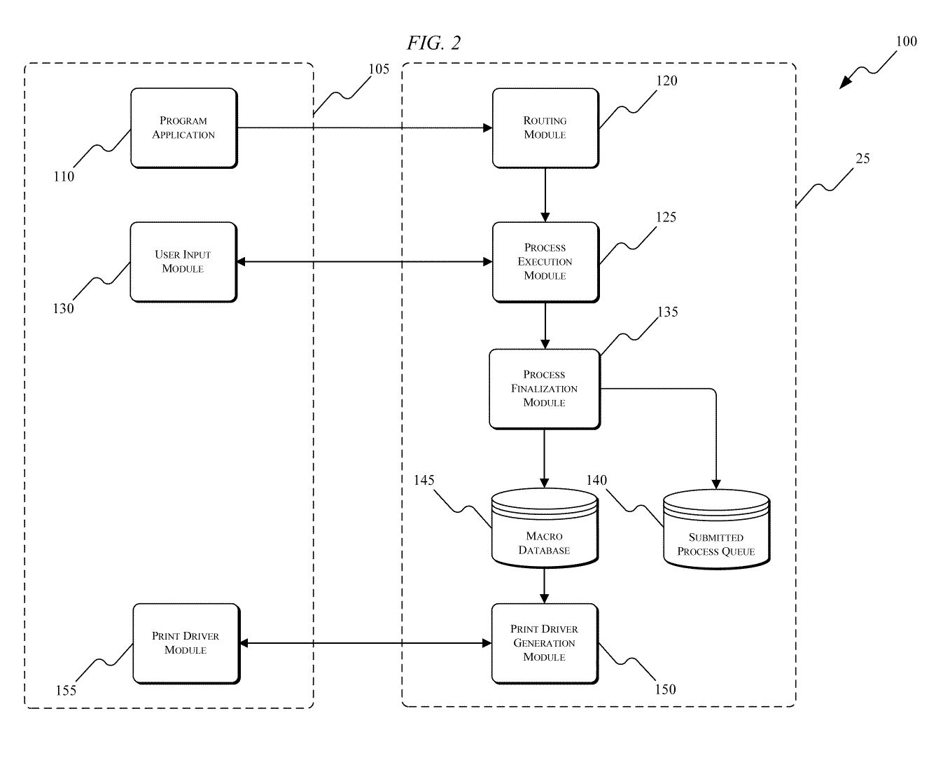

FIG. 2 illustrates a document flow process 100 for generating a customized print driver. A document is created at a client device 105 using, for example, a program application 110 such as a word processor or another suitable document creation application. The document is sent from the client device 105 to a host device 25 as an output data stream or print file following the selection of a previously installed or accessed process print driver. The process print driver is a general process print driver which is associated with a hosted document management service (e.g., FlyDoc). In some embodiments, the document is uploaded to a file transfer protocol (“FTP”) site or is emailed to the host device 25 as either an attachment to or in the body of the email. The process print driver sends, for example, the print file, client information, and document submitter information to a routing module 120 of the host device 25 through the network 20. The routing module 120 identifies and routs the received information to a process execution module 125. Upon the selection of the process printer driver, the print file from the program application is sent over the network 20 to the routing module 120 and a web-browser is initiated by the process execution module 125. In some embodiments, the process printer driver includes embedded information related to the client or the document submitter. This information is used to securely access a hosted document processing interface via the web-browser. In other embodiments, access to the interface is password protected and requires the entry of a username and password. In such embodiments, the login information is able to be saved such that entry of a username and password is not required each time a document is printed to the host device. Following the initiation of the web-browser and access to the document processing interface, the user is provided with one or more process description screens or pages (described below). The user enters information via a user input module 130 related to preferences for processing and distributing the document, such as transport type, transport preferences, etc. The user submits the preferences to the process execution module 125.

A process finalization module 135 receives the print file as well as the processing and distribution preferences from the process execution module 125. The process finalization module 135 performs two primary functions. First, the process finalization module 135 sends the document to a submitted process queue 140. In the submitted process queue 140, the document waits to be processed and distributed to one or more destinations (e.g., to a fax number, an email address, a postal address, etc.) according to the user submitted preferences. The process finalization module 135 also stores the processing and distribution preferences to a macro database 145. In some embodiments, the processing and distribution preferences for a document are automatically stored to the macro database 145. In other embodiments, the processing and distribution preferences are only stored to the macro database 145 when the user selects an option such as, for example, “SAVE AS TEMPLATE” or “GENERATE PRINT DRIVER.” For the purpose of this application, the term “macro” is defined as a non-executable set of parameters which specifies, for example, processing and distribution preferences for a document or group of documents. The macros are stored in the macro database 145 such that when the macro for the document is accessed, the parameters which were previously entered by the user are retrieved. In some embodiments, the macro database 145 is structured such that each of the parameters entered for a particular document are stored together and are referenced by a name such as “invoice 1” or another suitable identifier. In other embodiments, the parameters are stored in a relational database.

Following the storage of the document macro, a print driver generation module 150 generates a customized print driver. The customized print driver has, embedded within it, the document macro, a portion of the document macro, or a reference to the document macro. The customized print driver is generated such that when the customized print driver is selected and executed, the parameters which comprise the document macro are automatically retrieved and applied to the document without requiring further user intervention. The customized print driver is also published such that it is accessible by one or more users. For example, in some embodiments, the generated print driver is available to each employee of a particular company. The employees retrieve and install the print driver in a print driver module 155 or another memory of the client device 105. The printer driver is then selectable from, for example, a print menu of the program application.

In other embodiments, varying levels of access to the customized print drivers are established. For example, a company is likely to have several clients to which invoices and other documents are sent. In many instances, only a few employees regularly work with each client. Accordingly, access to customized print drivers related to a particular client is restricted to those employees who regularly do work with that client. Additionally or alternatively, a single person is able to access the customized print driver. In some embodiments, access to the customized print drivers is also restricted based on, for example, specialty, title, location, and the like to streamline the submission, processing, and distribution of documents.

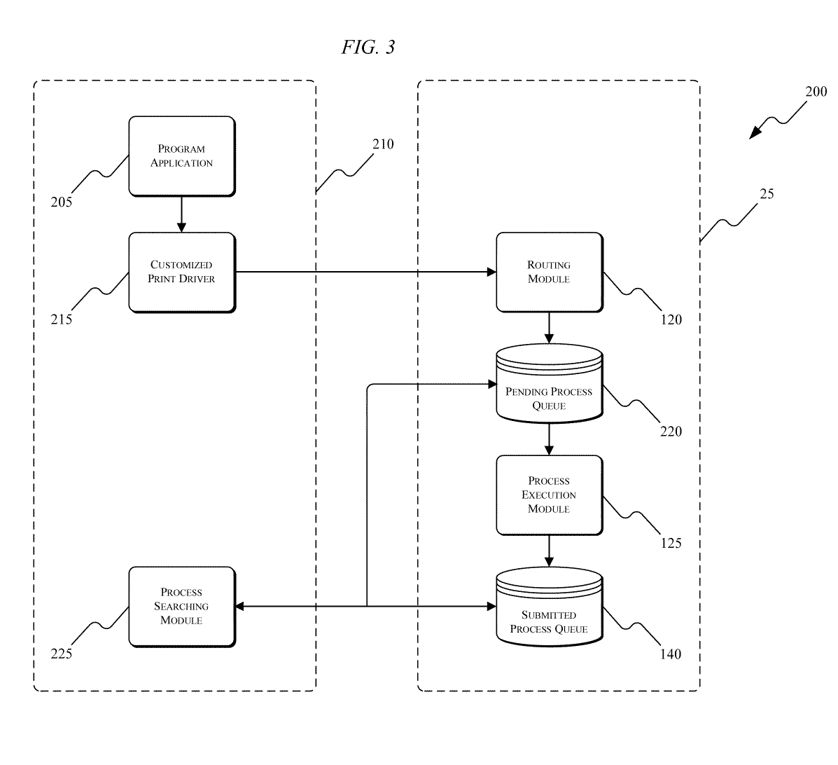

FIG. 3 illustrates a document flow process 200 for a document following the generation of the customized print driver. Similar to FIG. 2, the document is created using a program application 205 at a client device 210. The document is printed using the customized print driver 215, and the print file from the program application is sent to the host device 25. The routing module 120 routes the print file to a pending process queue 220 to await processing. From the pending process queue 220, the print file is sent to the process execution module 125. In some embodiments, the pending process queue 220 is not included and the print file is sent directly from the routing module 120 to the process execution module 125. In the process execution module 125, the parameters associated with the document macro are retrieved. As previously described, in some embodiments of the invention, the parameters are embedded within the print driver, and in other embodiments a reference to the document macro is embedded within the print driver. Embodiments of the invention provided herein are described with respect to an implementation in which a reference to the document macro is embedded within the print driver.

The parameters which comprise the document macro are retrieved, applied to, or associated with the print file in the process execution module 125. For example, if the processing and distribution preferences for a particular document include information for mailing a hard copy of the document to a destination, a transport type and transport options are stored as parameters in the document macro. The process execution module 125 combines the print file with the parameters stored as the document macro and prepares the combination of the information for submission to, for example, a mail and print service by way of the submitted process queue 140. A user also has the ability to search both the pending process queue 220 and the submitted process queue 140 using a process searching module 225. The process searching module 225 is, for example, a browser which accesses the document processing interface. In other embodiments, the process searching module 225 is an add-on or module within a program application or an email client. Additionally or alternatively, the pending process queue 220 and the submitted process queue 140 are searched using another Internet-enabled device (i.e., a device other than the client device 210).

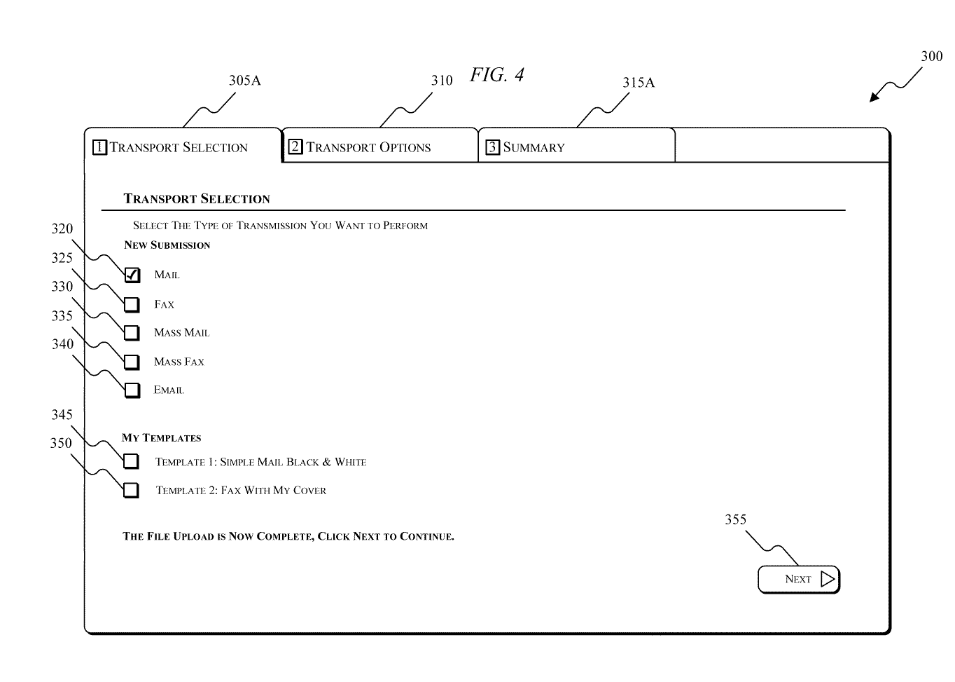

FIG. 4 illustrates a document processing interface 300. As illustrated, the interface 300 includes a transport selection tab 305A, a transport options tab 310, and a summary tab 315A. In other embodiments of the invention, additional or different tabs are included in the interface 300, such as a pending process queue tab, a submitted process queue tab, a printer driver tab, etc. Alternatively, a tabbed document processing interface is not used, and one or more individual web-pages or screens are provided. The transport selection tab 305A of the interface 300 includes input portions (e.g., text boxes, check boxes, etc.) for receiving selections from a user. For example, in one embodiment, the user populates the input portions of the interface 300 by entering text via a mechanical or virtual keyboard of a client device, and using a pointing or selection device such as a mouse to control a curser on a display screen. Input signals from the keyboard and the mouse are received and processed by a computer (e.g., including a processor and a memory) and translated into a visual result or action in the interface. For example, if the user enters text using a keyboard, the activated keys produce signals which are represented as type-written text in the interface 300. Similarly, a mouse click which corresponds to a location of the cursor on the screen results in selecting/deselecting a check box, highlighting text, etc. In other embodiments, the interface 300 is accessed using a touch-screen device and a user's finger strokes or tapping are used to populate the input portions.

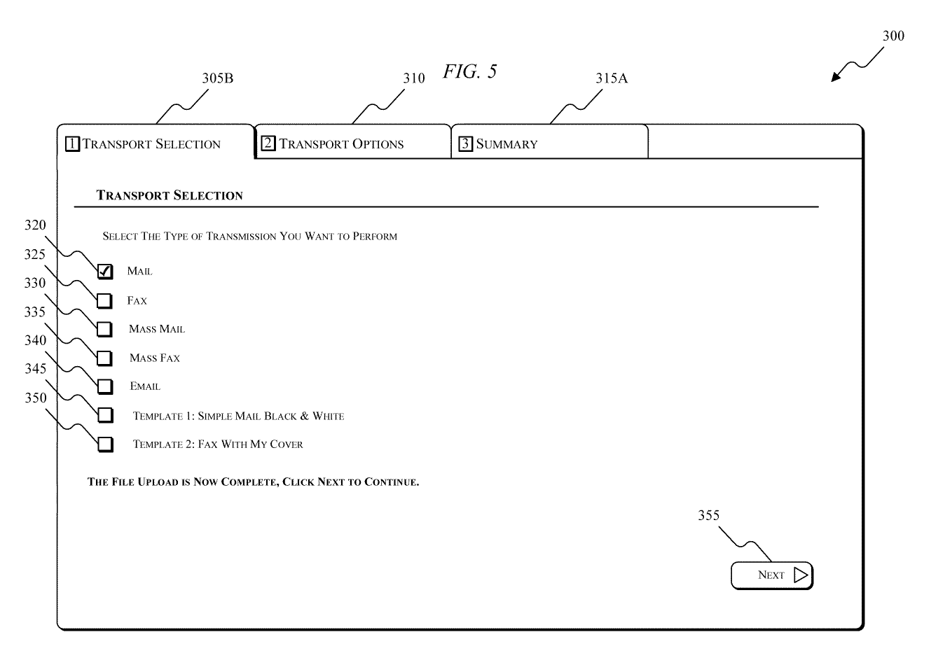

The transport selection tab 305A allows a user to make a transport selection corresponding to the document which was printed. For example, if the document was printed to the process print driver for the first time and no customized print driver has been created to automate the processing of the document, the user selects one or more of a “MAIL” checkbox 320, a “FAX” checkbox 325, a “MASS MAIL” checkbox 330, a “MASS FAX” checkbox 335, and an “EMAIL” checkbox 340. In some embodiments, the user selects multiple types of transports to send the document to one client in multiple ways. In other embodiments, the user selects multiple types of transports to send the document to a first client using a first transport type and a second client using a second transport type. Such embodiments are used, for example, when multiple documents are created at the same time but for different clients, or the same document is to be sent to multiple clients. Additionally or alternatively, a template is selected which has a predefined set of processing and distribution preferences. For example, templates are created which correspond to a specific document and how the document is to be processed and distributed, or templates are created which correspond to generic processing and distribution parameters which are applicable to a variety of documents. In such instances, the template is used to expedite navigation of the document processing interface 300. The transport selection tab 305A illustrates two such templates. A “TEMPLATE 1” checkbox 345 is used to select, for example, a simple mailing in black and white ink. A “TEMPLATE 2” checkbox 350 is used to select a fax with a generic cover sheet. The cover sheet corresponds to a document which was previously printed to the process print driver or otherwise provided to the host device 25. The host device 25 accesses the cover sheet or another previously saved document which is then appended to the document for processing and distribution. A “NEXT” input device or button 355 is selected to navigate to the remaining tabs of the interface 300. An alternative embodiment of the transport selection tab 305A is illustrated in FIG. 5 as transport selection tab 305B. The transport selection tab 305B is similar to the transport selection tab 305A, but the transport selection options are included in a single group of selection options.

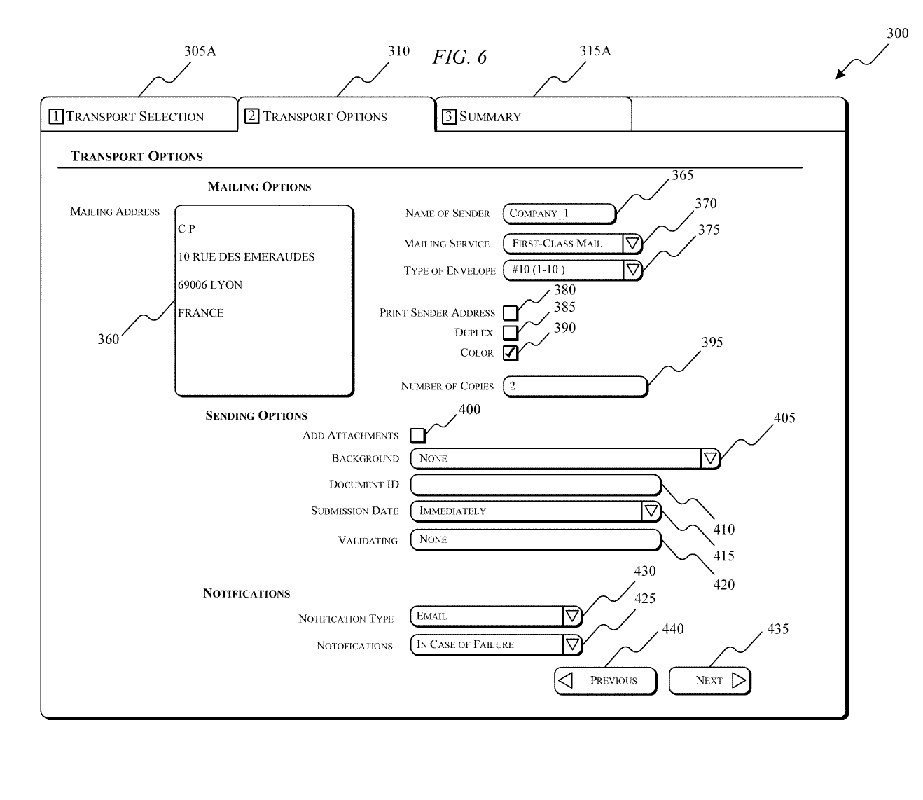

FIG. 6 illustrates the transport options tab 310. Although the illustrated transport options tab 310 is related to a transport selection of “MAIL,” similar transport options tabs are used for the remaining transport selection options (e.g., fax, mass mail, email etc.). The transport options tab includes, for example, a mailing options section, a sending options section, and a notifications section. The mailing options section allows the user to select specific mailing preferences for the document. The mailing options section includes a mailing address text box 360 for entering a recipient's mailing address, and a sender name text box 365 or similar data entry element which allows the user to manually enter or select the name of the sender (e.g., company name, user name, etc.). In some embodiments, the sender name text box 365 is populated automatically based on information related to a client account. The mailing options section also allows the user to select a mail service using a mailing service text box 370 (e.g., first-class mail) and an envelope type using an envelope type text box 375 (e.g., #10, #12, #14, etc.). The mailing options section also includes a check box 380 that allow the user to select whether the sender address is to be included, a checkbox 385 to indicate whether the document is to be printed duplex (e.g., front and back), a checkbox 390 to indicate whether the document is to be printed in color, and a text box 395 to indicate the number of copies of the document to be mailed.

The sending options section allows the user to select specific sending options related to the document. For example, the user selects, using corresponding input elements, whether any attachments are to be included (e.g., additional documents, cover letters, etc.) using an add attachments check box 400, whether a background is to be included on the printing paper using a background text box 405, and whether a document ID is to be included using a document ID text box 410 (e.g., an ID for identifying the document within a document management system or archive). The sending options section also allows the user to select a submission or mailing date for the digital document using a submission date text box 415 (e.g., immediately, next day, next week, last day of the month, etc.), and whether the mailing is to include validating information using a validation text box 420 (e.g., confirmation of receipt by the recipient).

The notifications section allows the user to define one or more criteria using a notifications text box 425 for which notification messages are sent to one or more users. For example, the user selects a notification type (e.g., an email, a text message, fax, etc.) using a notification type text box 430 to be sent upon the successful completion of the mailing, the failure of the mailing, and the like. In some embodiments, the user is notified via email or text message when a status of the mailing has changed (e.g., when the document is sent, when the document is in queue, etc.). A “NEXT” button 435 and a “PREVIOUS” button 440 are used to navigate to the other tabs of the interface 300.

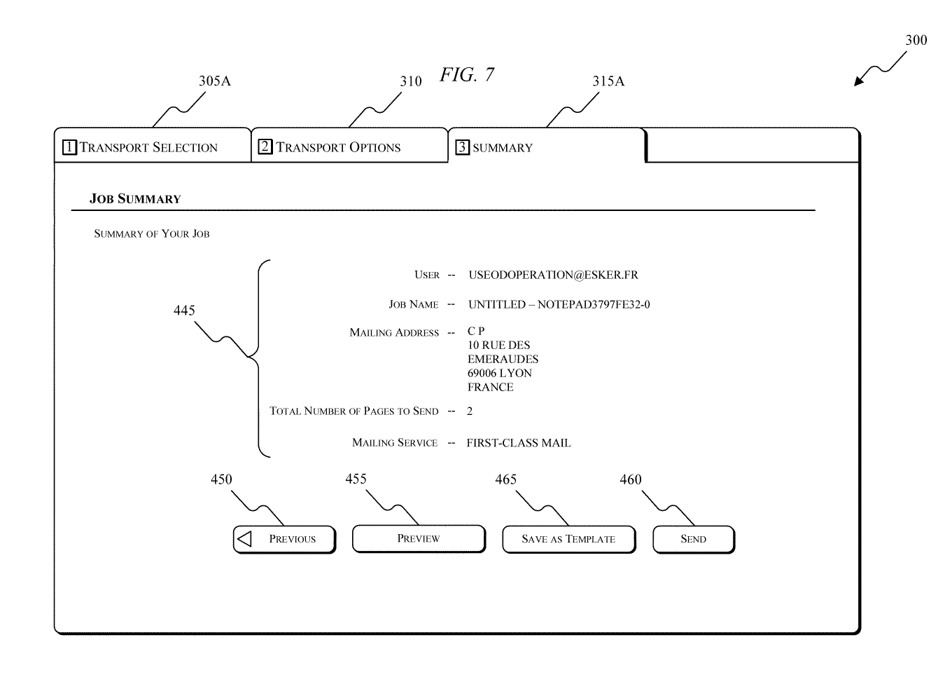

FIG. 7 illustrates the summary tab 315A. The summary tab 315A provides the user with an opportunity to review a summary 445 of selected information and preferences related to the document. For example, in the illustrated embodiment, a user name, a job name, the mailing address, the total number of pages, and the type of mailing service are provided in the summary 445. In other embodiments, the summary 445 is more comprehensive and includes other processing and distribution preferences such as type of envelope and notifications. A “PREVIOUS” button 450 allows a user to navigate back to the transport options tab 310 or the transport selection tab 305A or 305B. A “PREVIEW” button 455 allows a user to preview the documents which will be sent to the recipient. A “SEND” button 460 initiates the sending of the document and a “SAVE AS TEMPLATE” button 465 causes a template to be created. As previously described, templates are created to expedite the processing and distribution of a document. The templates generally correspond to basic transport preferences. For example, first-class mail, one copy, and #10 envelope. The user selects the template to forgo having to continually enter each processing and distribution preference.

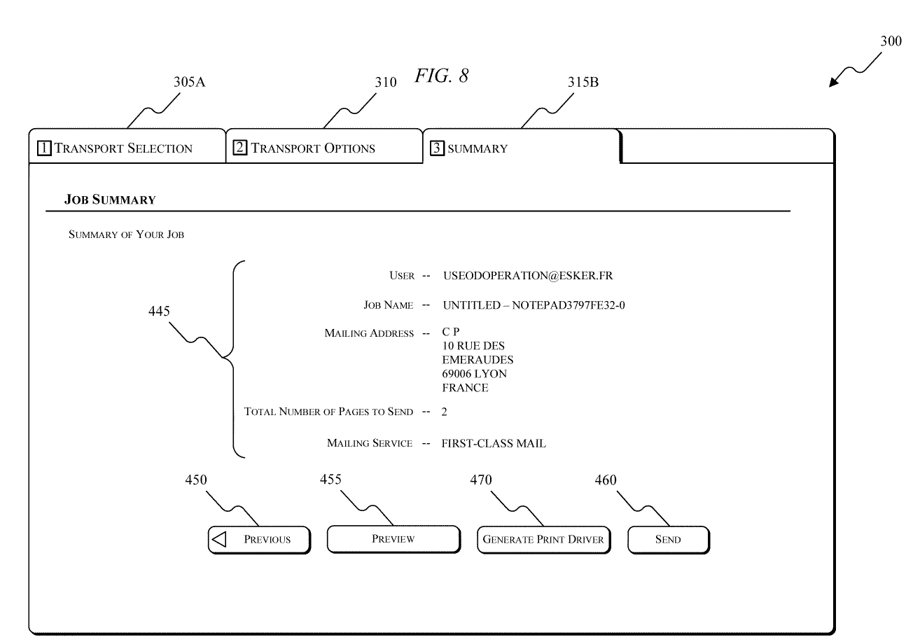

FIG. 8 illustrates another summary tab 315B. The summary tab 315B is similar to the summary tab 315A of FIG. 7 except the “SAVE AS TEMPLATE” button 465 is replaced with a “GENERATE PRINT DRIVER” button 470. The “GENERATE PRINT DRIVER” button 470 causes the processing and distribution preferences entered by the user to be incorporated into a customized print driver, as is described in greater detail below. In some embodiments, the processing and distribution preferences are automatically saved as a set of parameters or macro. In other embodiments, the transport information is not saved as a set of parameters or macro until the user selects the “GENERATE PRINT DRIVER” button 470. The generated macro corresponding to the processing and distribution preferences is stored in a memory of the host device 25 or a database (e.g., database 30) as previously described. In some embodiments, the “GENERATE PRINT DRIVER” button 470 causes both a customized print driver and a template to be created. In other embodiments, the “GENERATE PRINT DRIVER” button 470 causes a customized print driver to be created and the host device to initiate the sending of the document to one or more destinations.

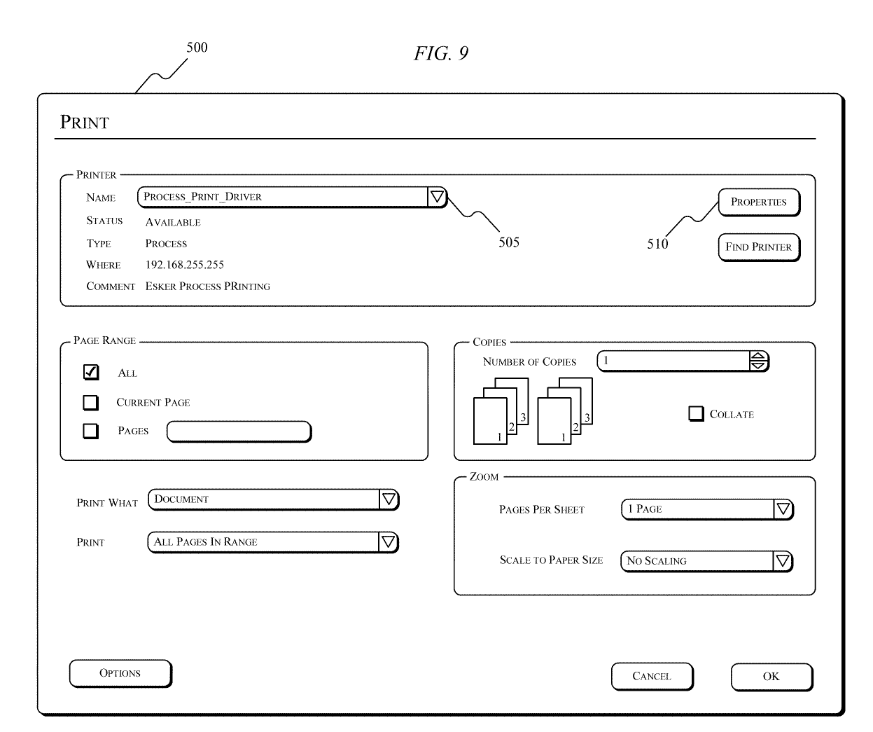

FIG. 9 illustrates a process printing interface 500. Unlike the document processing interface 300 described above, the process printing interface 500 is accessed before the document is printed. The process printing interface 500 resembles a standard printer selection interface used by, for example, a word processor or spreadsheet. However, instead of selecting a standard printer, a general process print driver or customized print driver 505 is selected, which causes the print file of the program application to be uploaded to the host device 25. Unlike the document processing interface 300, the processing and distribution preferences are entered or verified before the document is printed.

For example, a standard printer allows a user to modify print parameters such as printer tray, ink color, and the like before printing. By selecting the “PROPERTIES” button 510 in the process printing interface 500, the user accesses process printing options which are substantially similar to those previously described with respect to FIGS. 4-8. As such, the user is able to enter processing and distribution preferences before the document is printed, and is able to forgo having to enter such information via the document processing interface 300. Additionally, after a customized print driver 505 is created, the user is able to access and modify default (e.g., previously selected) processing and distribution preferences. Such a feature is advantageous when a small number of parameters have changed. As such, the user does not need to create a new customized print driver to accommodate relatively few or minor changes. The access to and modification of processing and distribution parameters are enabled when the customized print driver is created. Additionally or alternatively, the processing and distribution preferences corresponding to a customized print driver are able to be accessed and modified using the document processing interface 300.

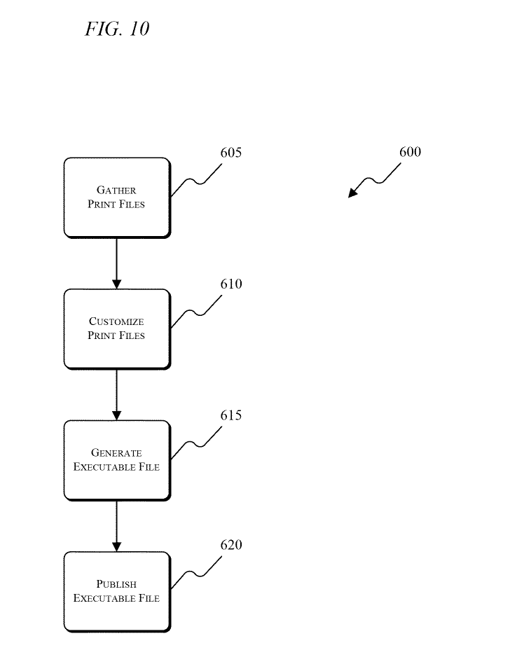

A process 600 for generating a customized print driver is illustrated in FIG. 10. Following the selection of, for example, the “GENERATE PRINT DRIVER” button 470 of FIG. 8, the host device 25 gathers the print files necessary to create a customized print driver (step 605). The gathered print files are then customized (step 610). For example, the print files are modified in accordance with a document macro. Following the customization of the print files, an executable file (e.g., the customized print driver) is generated (step 615). The executable file is then published (step 620).

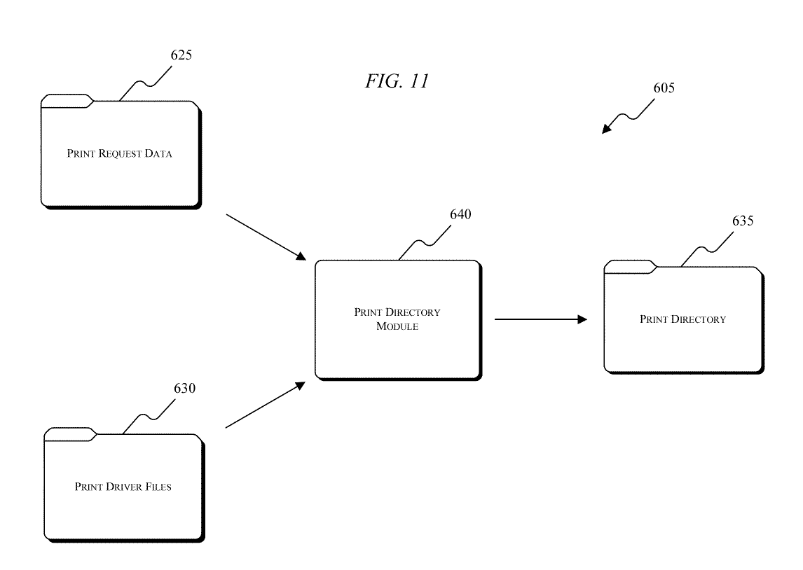

FIG. 11 illustrates step 605 of the process 600 in greater detail. Following the activation of the “GENERATE PRINT DRIVER” button 470, the host device 25 gathers the files necessary to generate the customized print driver and saves them to a print directory. For example, the host device 25 gathers print request data 625 which includes files related to a printer name, a macro name, and display options (e.g., a skin) associated with the user's identity (e.g., company name, name of subscriber, etc.). The generation of a customized print driver also requires print driver files 630. The print driver files include the reference files related to, for example, port monitoring, setup, skins, printer driver engines, and parameter initialization. After the host device 25 has gathered the files, a print directory 635 is created by a print directory module 640 containing the files necessary for generating the customized print driver. The print directory 635 is stored in a memory internal to the host device 25 or in a memory that is connected to the host device, such as the database 30. The print directory 635 is designated with a name that corresponds to, for example, the print request data 625.

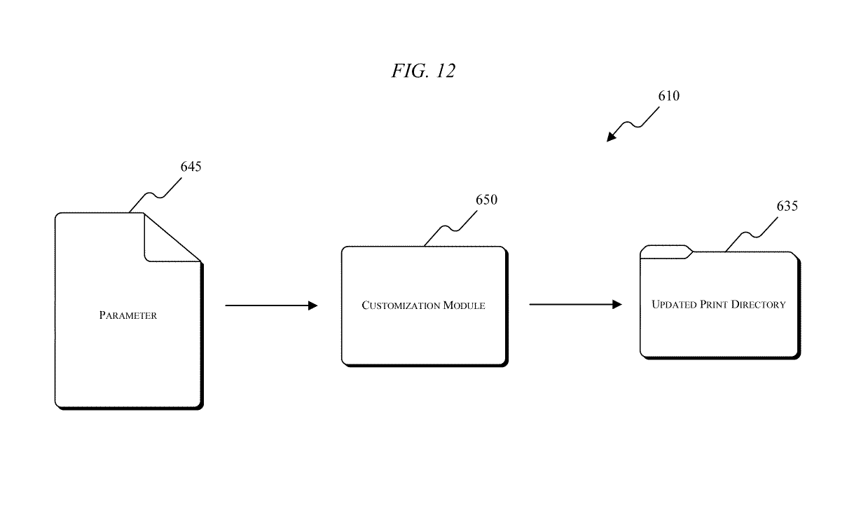

The customization of the print file is illustrated in FIG. 12. The customization of the print files includes, among other things, combining, embedding, or otherwise associating one or more document macros with the files in the print directory 635. In the embodiment illustrated in FIG. 12, a parameter initialization file 645, designated as “PARAMETER,” is used to associate the one or more macros with a print driver. PARAMETER includes fields such as macro name, ID, skin, etc. This file is tagged according to the print request files by a customization module 650. For example, PARAMTER is tagged according to user account information (e.g., printer name, etc.), and is tagged such that at least a reference (e.g., a memory address, a URL, a macro name, a call number, etc.) to the document macro that includes the processing and distribution preferences is embedded within the file. The print directory 635 is then updated with the tagged version of PARAMETER.

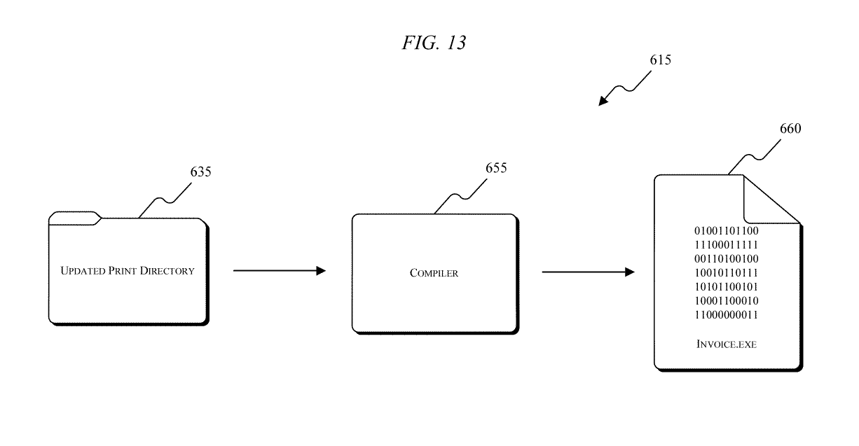

FIG. 13 illustrates step 615 of the process 600 in greater detail. The updated print directory 635 includes the files necessary to generate a customized print driver according to the user's processing and distribution preferences for a document. The files within the print directory 635, or the print directory itself, are compiled in a compiler or similar program 655 which creates an executable file 660, which is designated as INVOICE.EXE in the illustrated embodiment. The file 660 is a customized print driver for processing and distributing invoices. In other embodiments, a user or client name is included in the name of the customized print driver to make the print driver easier to locate in a list of available customized print drivers. In some embodiments, the executable file 660 is a self-extracting executable file.

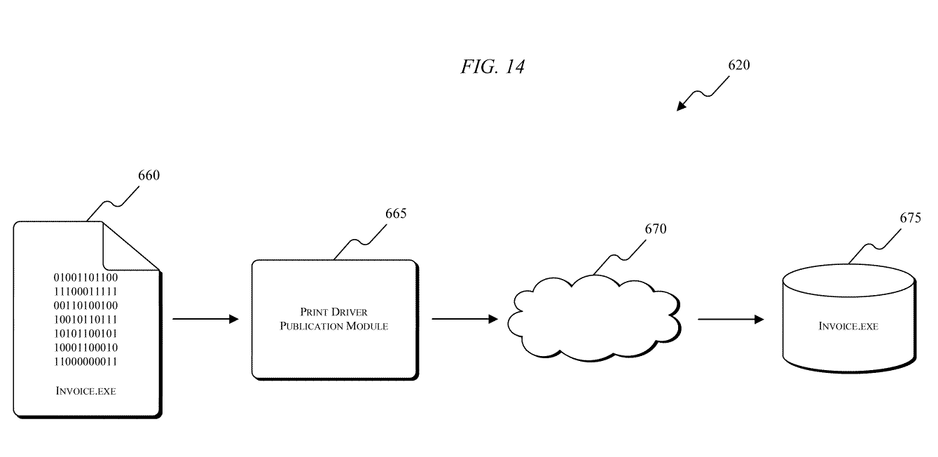

FIG. 14 illustrates step 620 of the process 600 in greater detail. The generated executable file 660 is published using a print driver publication module 665 which makes the complete executable file 660 or a link to the executable file 660 accessible by one or more users. For example, the executable file is uploaded to a public or secured website which enables users to access the file through a network 670 and save or install the file in a memory 675 of one or more client devices.

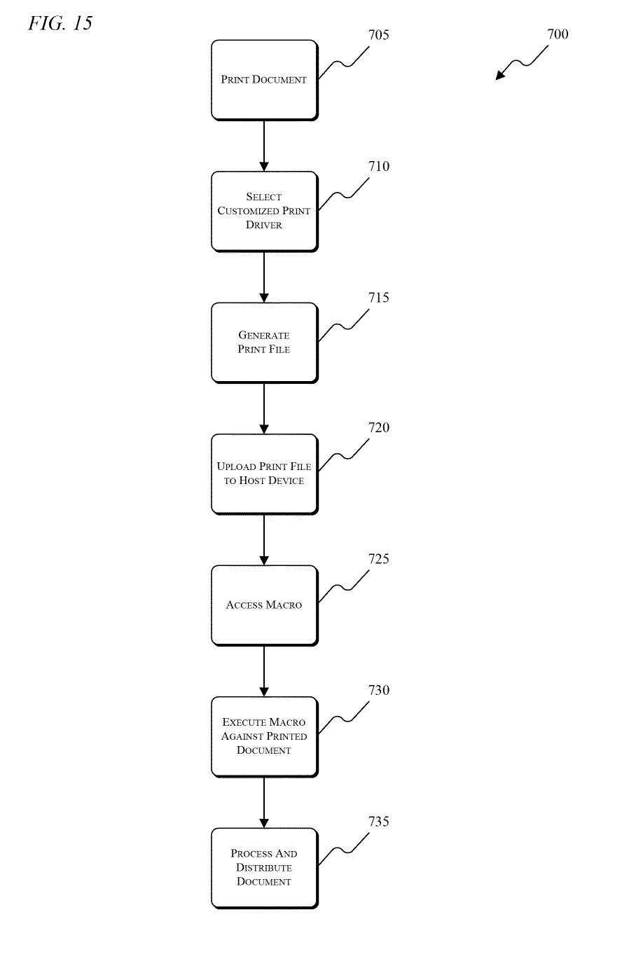

After the customized print driver has been published, the customized print driver is available for use. FIG. 15 illustrates a process 700 utilizing the customized print driver to process and distribute a document. As previously described, the document is created using an application such as, for example, a word processor. The user selects a print option from the word processor to print the document (step 705). After the user has selected a print option, the user selects the customized print driver (step 710) which corresponds to the document being printed. For example, for a single company, a variety of customized print drivers may be available. The various customized print drivers correspond to different documents, or to different versions of a particular type of document. As an illustrative example, companies often have invoices which are tailored to their clients needs. Accordingly, a customized print driver labeled, for example, “COMPANY1_INVOICE_MAIL” or “COMPANY2_INVOICE_FAX” is selected to print the document. Following the selection of the customized print driver and an acknowledgment that the document is to be printed, not further user intervention is necessary. As such, the customized print driver enables single-click document processing and distribution.

The customized print driver captures operating system printer commands and generates an output data stream or print file (step 715) in one of a variety of formats. For example, the print file corresponds to a file format such as portable document format (“PDF”), PostScript (“PS”), printer command language (“PCL”), or a proprietary format. At the end of the printing, a port monitor uploads the print file to the host device 25 (step 720) and the macro is accessed (step 725). In some embodiments, a web browser is launched to access the macro associated with the customized print driver after the print file has been uploaded. Alternatively, the macro is accessed before the print file is uploaded to the host device 25, and the macro or the reference to the macro is uploaded to the host device 25 with the print file. In other embodiments, a verification or confirmation step is included. For example, the document processing interface 300 is accessed and the user is presented with the summary tab 315A or 315B illustrating the corresponding processing and distribution parameters. After the host device 25 has accessed the macro, the macro is executed against the printed document (step 730). The document is then processed and distributed as defined by the macro (step 735).

Thus, the invention provides, among other things, systems and methods for generating a customized print driver and automating document processing and distribution. Various features and advantages of the invention are set forth in the following claims.

What is claimed is:

1. A method of automatically processing and distributing a document to at least one of a plurality of destinations, the plurality of destinations including a fax number, an email address, and a postal address, the method comprising:
receiving, at a host device, a print file from an Internet-enabled device;
generating at least one macro based on processing and distribution parameters received from a user;
storing the at least one macro based at least in part on the processing and distribution parameters;
generating a customized print driver based on the at least one macro, wherein a reference to the at least one macro is embedded within the customized print driver;
making the customized print driver available to the Internet-enabled device; and
preparing the print file for distribution to at least one of the plurality of destinations based on the processing and distribution parameters included within the at least one macro.

2. The method of claim 1, further comprising allowing the customized print driver to be installed on the Internet-enabled device.

3. The method of claim 1, further comprising receiving, at the host device, a second print file sent using the customized print driver.

4. The method of claim 3, further comprising accessing the at least one macro embedded within the customized print driver.

5. The method of claim 4, further comprising combining the second print file with the at least one macro.

6. The method of claim 1, wherein the processing and distribution parameters include a transport medium, transport options, and contact information.

7. A method of distributing a document to at least one of a plurality of destinations, the method comprising:
receiving, at a host device, a print file from a client device,
wherein the print file is sent to the host device using a customized print driver; and
accessing at least one macro based on information embedded within the customized print driver,
wherein the at least one macro includes a set of parameters related to processing and distribution preferences for the print file, and
wherein the print file is prepared for distribution based on the at least one macro.

8. The method of claim 7, wherein the at least one macro includes a selection of at least one of the plurality of destinations.

9. The method of claim 8, wherein the plurality of destinations include a fax number, an email address, and a postal address.

10. A system for initiating distribution of a document to at least one of a plurality of destinations, the system comprising:
a client device configured to
transmit a print file using a customized print driver; and
a host device including a memory and a processor, the processor connected to the memory and configured to
access at least one macro based on information embedded within the customized print driver,
wherein the print file is prepared for distribution to at least one of the plurality of destinations based on information included within the at least one macro.

11. The system of claim 10, wherein the plurality of destinations includes a fax number, an email address, and a postal address.

12. The system of claim 10, wherein the at least one macro includes a set of parameters related to processing and distribution preferences for the print file.

13. The system of claim 12, wherein the set of parameters related to processing and distribution preferences includes a selected one of the plurality of destinations.

14. The system of claim 10, further comprising a second client device configured to transmit a second print file to the host device using the customized print driver.

15. A device for initiating distribution of a document to at least one of a plurality of destinations, the device comprising:
a memory; and
a processor connected to the memory and configured to
receive a print file; and
access at least one macro based on information embedded within a customized print driver,
wherein the at least one macro includes a set of parameters related to processing and distribution preferences for the print file, and
wherein the print file is prepared to be distributed to at least one of the plurality of destinations based on information included within the at least one macro.

16. The device of claim 15, wherein the plurality of destinations includes a fax number, an email address, and a postal address.

17. The device of claim 15, wherein the set of parameters related to processing and distribution preferences includes a selected one of the plurality of destinations.

18. The device of claim 15, wherein the processor is further configured to generate at least a second customized print driver.

19. The device of claim 18, wherein the processor is further configured to publish the second customized print driver, and
wherein the second customized print driver is accessible via a network.

20. The device of claim 19, wherein the processor is further configured to access a second macro based on information embedded within the second customized print driver.
